(19) United States
(12) Patent Application Publication
(10) Pub. No.: US 2008/0059903 A1
(43) Pub. Date: Mar. 6, 2008

(54) Image display method, image display apparatus and camera

(76) Inventors: Tomomi Kaminaga, Tokyo (JP); Osamu Nonaka, Sagamihara-shi (JP)

Correspondence Address: STRAUB & POKOTYLO, 620 TINTON AVENUE, BLDG. B, 2ND FLOOR, TINTON FALLS, NJ, 07724, US

(21) Appl. No.: 11/897,324

(22) Filed: Aug. 29, 2007

(30) Foreign Application Priority Data
Sep. 6, 2006 (JP) 2006-241679

(51) Int. Cl. H04N 5/222; G06F 3/048

(52) U.S. Cl. 715/797; 348/333.05; 348/E05.022

(57) ABSTRACT

Disclosed are an image display method, an image display apparatus and a camera, which display a list of a plurality of images arranged in such a way that individual images at least partially overlie one another, sequentially enlarge and display the images in the displayed list, and cause the enlarged and displayed images to disappear from a screen. In displaying a list of images, the images can be arranged in such a way that an important portion of each image is not hid by another image. Schemes of causing an image to disappear from the screen include fade-out of an image and movement of an image out of the screen.

### CROSS REFERENCES TO RELATED APPLICATION

This application is based upon and claims the benefit of priority from prior Japanese Patent Application No. 2006-241679, filed on Sep. 6, 2006, the entire contents of which are incorporated herein by reference.

### BACKGROUND OF THE INVENTION

1. Field of the Invention

The present invention relates to an image display method, and image display apparatus, which manage and display images or the like captured by a camera, and a camera which manages and displays captured images or the like.

2. Description of the Related Art

There are a display method of displaying a list of images captured by a digital camera or the like on a monitor in a thumbnail form and a display method of sequentially displaying images in the captured order according to a camera user. Because such a display method appears dull, there have been proposals of displaying images in a slide show manner with music played as BGM.

For example, there has been a proposal of changing the display effect according to the size of a face or the like included in a displayed image or the number of faces included therein (see Japanese Patent Application Laid-Open No. 2005-182196, for example).

The technique described in Japanese Patent Application Laid-Open No. 2005-182196 displays only a single image at a time.

### BRIEF SUMMARY OF THE INVENTION

Accordingly, an image display method of the present invention displays a list of a plurality of images arranged in such a way that individual images at least partially overlie one on another, sequentially enlarges and displays the images in the displayed list, and causes the enlarged and displayed images to disappear from a screen.

As an exemplary structure of the image display method of the present invention, an image display method for displaying a plurality of input images on a display part, comprising: selecting and sequentially inputting a plurality of images to be displayed; displaying a list of the sequentially input plurality of images on the display part in such a way that the displayed images at least partially overlap one another; and sequentially enlarging and displaying individual images in the displayed list, and then causing the enlarged and displayed images to disappear from a screen of the display part.

The present invention can be understood as an invention of an image display apparatus and an invention of a camera.

### BRIEF DESCRIPTION OF THE SEVERAL VIEWS OF THE DRAWINGS

These and other features, aspects, and advantages of the apparatus and methods of the present invention will become better understood with regard to the following description, appended claims, and accompanying drawings where:

FIG. 1 is a block diagram showing the basic configuration of a digital camera according to one embodiment of the present invention;

FIG. 2 is a flowchart for explaining the shooting operation of the camera according to the embodiment of the present invention;

FIGS. 3A and 3B are diagrams showing examples of scenes taken;

FIGS. 4A and 4B are diagrams showing examples of how to overlay images in a case of displaying a list of images;

FIGS. 5A to 5D are diagrams for explaining an example of determining if there is a person in a screen based on facial detection;

FIGS. 6A and 6B are diagrams showing examples of how to overlay images each containing an important portion in a case of displaying a list of images;

FIG. 7 is a flowchart for explaining an operation of a sub routine “list display” in step S15 in the flowchart in FIG. 2;

FIGS. 8A and 8B are diagrams showing examples of enlargement and display;

FIG. 9 is a flowchart for explaining an operation of a sub routine “enlargement and display” in step S16 in the flowchart in FIG. 2;

FIGS. 10A and 10B are diagrams for explaining selection of an important portion in an image;

FIG. 11 is a flowchart for explaining an operation of a sub routine “determination of important portion of last image” in step S22 in the flowchart in FIG. 7;

FIGS. 12A and 12B are diagrams for explaining determination of an area which has a high chroma and a large color change;

FIG. 13 is a diagram showing an example of a chromaticity diagram when RGB signals are expressed through a predetermined coordinate conversion by XYZ coordinates of a CIE display color system or the like as color space with luminance taken on the Y axis;

FIGS. 14A and 14B are diagrams for explaining determination of an area which has a large contrast change; and

FIG. 15 is a flowchart for explaining an operation of a sub routine “determination of important portion of displayed image” in step S25 in the flowchart in FIG. 7 and in step S32 in the flowchart in FIG. 9.

### DETAILED DESCRIPTION OF THE PREFERRED EMBODIMENT

A preferred embodiment of the invention is described below with reference to the accompanying drawings.

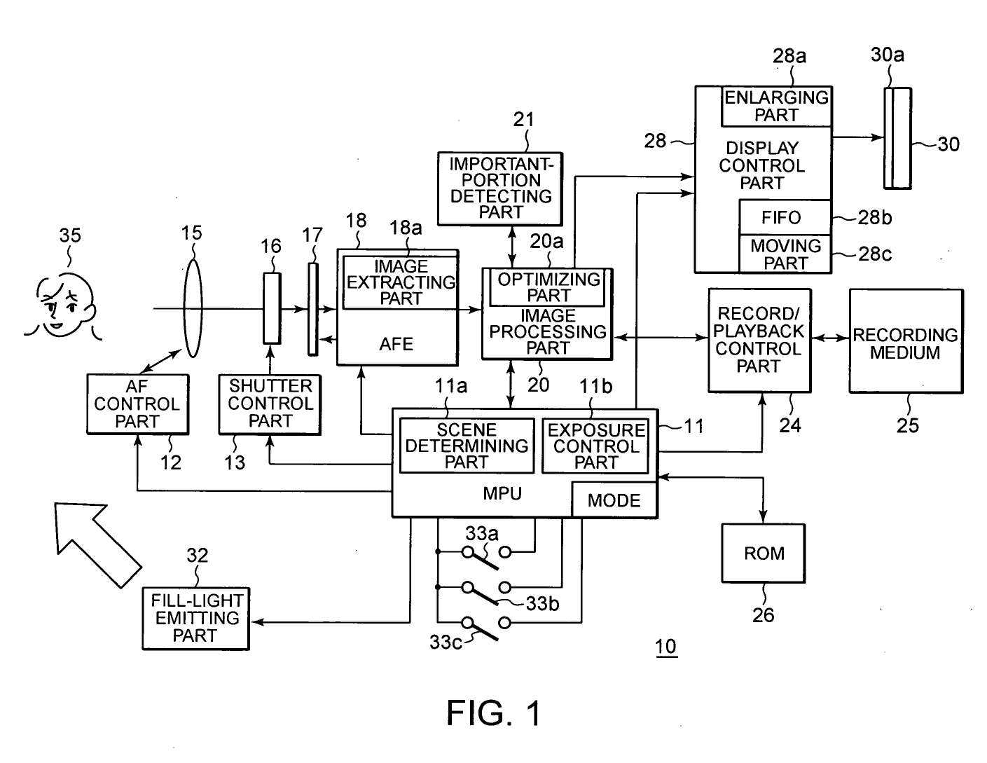

Referring to FIG. 1, a camera of the present invention will be described.

FIG. 1 is a block diagram showing the basic configuration of a digital camera 10 according to one embodiment of the present invention. The digital camera (hereinafter “camera”) 10 has a main CPU (hereinafter “MPU”) 11, an auto focus (AF) control part 12, a shutter control part 13, a lens part 15, a shutter 16 and an image pickup device 17. The camera 10 further includes an analog front end (AFE) part 18, an image processing part 20, an important-portion detecting part 21, a record/playback control part 24, a recording medium 25, an ROM 26, a display control part 28, a display part 30, a fill-light emitting part 32, and an operation part comprising a plurality of switches 33a, 33b, 33c.

The MPU 11 having the functions of a control part comprises a micro-controller or the like and detects various operations made by a user according to the states of the switches 33a, 33b, 33c. The MPU 11 sequentially controls the aforementioned individual blocks at the time of shooting according to the results of detecting the states of the switches 33a, 33b, 33c and a predetermined program. The MPU 11 performs the general control of the camera 10, such as shooting and playback, according to the program. The ROM 26 connected to the MPU 11 is a non-volatile and recordable memory (storage part), and is constituted by, for example, a flash ROM. A control program for executing control processes of the camera 10 and facial similarity patterns to be described later are stored in the ROM 26.

Each of the switches 33a, 33b, 33c notifies the MPU 11 of an instruction from a camera user. While the switches 33a, 33b, 33c are illustrated as a typified example of the operation part, the switches are not restrictive. The operation part may include other switches than the switches 33a, 33b, 33c. The switch 33a is a release switch, and the switches 33b and 33c may be switches for changing the record/playback mode and changing the shooting mode and display mode. For example, an operation of increasing the intensity of a backlight to be described later to make the liquid crystal display of the display part in a bright scene is also executed by the switch control. The MPU 11 detects a user instruction of shooting, display or the like based on the state of the switch 33a, 33b, 33c.

An image of a subject 35 is received by the image pickup device 17 as an imaging part, which comprises a CMOS sensor or CCD having multiple light-receiving elements (pixels) via the lens part 15 and the shutter 16. The image pickup device 17 converts the image into an electrical signal, which is converted to a digital signal by the AFE part 18 including an A/D conversion part. The digital signal is input to the image processing part 20.

The lens part 15 forms the input image of the subject 35 on the image pickup device 17. The shutter 16 selectively shields light passing through the lens part 15 and entering the image pickup device 17 to adjust the amount of exposure.

The AF control part 12 controls the focus position of the lens part 15. The control of the focus position is executed in response to a control signal which is output to the AF control part 12 from the MPU 11 as the image processing part 20 detects the contrast of image data output from the image pickup device 17 and outputs a contrast signal to the MPU 11. The MPU 11 outputs the control signal to the AF control part 12 in such a way that the contrast signal of the image data becomes maximum.

The shutter control part 13 controls the opening/closing of the shutter 16. The shutter control part 13 performs exposure control to keep the amount of incident light to the image pickup device 17 to a predetermined amount by closing the shutter 16 in a short period of time when the input light is bright, and closing the shutter 16 after a long period of time when the input light is dark.

There may be a case where the shutter control part 13 performs exposure control using an ND filter and an aperture part (neither shown) located between the lens part 15 and the image pickup device 17. The image pickup device 17 such as a CCD and the display part 30, both of which will be described later, unlike the conventional photographic film and print, have a narrow dynamic range and are thus difficult to distinctly display brightness and darkness. To cope with the problem, the image processing control mentioned above and backlight control are effectively used in addition to the exposure control to cope with various scenes.

The image pickup device 17, which comprises a CMOS or CCD, converts the formed image of a subject to an image signal. The AFE part 18 converts an analog electric signal output from the image pickup device 17 to digital image data, and outputs the digital image data. The AFE part 18 is provided with an image extracting part 18a. The image extracting part 18a can select signals from signals output from the image pickup device 17, and extract only image data in a limited range or thinned pixel data from image data corresponding to the entire light-receiving surface. Because the image size displayable on the panel of the display part 30 is limited, for example, display control is performed to reduce the number of pixels limited beforehand. This can ensure fast display control, thereby making it possible to process signals input to the image pickup device 17 in real time and display the signals approximately at the same time, so that the user can shoot the subject while viewing the display. Therefore, a special optical finder or the like may not be provided. It is to be noted that because the panel of the display part 30 is not easy to see under a strong sun light or the like, a backlight is provided and the brightness adjusting part 30a is provided to be able to change the brightness thereof. This configuration can change the brightness of the backlight automatically or according to the user's operation.

The image processing part 20 performs gamma correction (gradation correction) and a process of correcting colors, gradations and sharpness. The image processing part 20 has a compressing/decompressing part for a still image at the JPEG (Joint Photographic Coding Experts Group) core portion (not shown). At the time of shooting, the compressing/decompressing part compresses image data. In addition, the image processing part 20 is provided with an optimizing part 20a which determines the distribution of brightness an image has, and adequately amplifies bright portions with respect to dark portions to improve the visibility.

Using information acquired at the time of shooting, the important-portion detecting part 21 detects if there is a person's face present in the subject (facial detection), and detects an important portion of an image from a clear color portion in the image or a high/low contrast portion therein, or the like. In the facial detection, a face is detected based on image data output from the image processing part 20 by using information at the time of focusing and/or by extracting a feature point from a monitor image to be described later. The important-portion detecting part 21 outputs information on the size and position of the face in the screen, a change in high/low contrast, the position of a clear color portion, etc. to the MPU 11.

The image data compressed in the image processing part 20 is recorded in the recording medium 25, which stores images, via the record/playback control part 24. The record/playback control part 24 reads image data from the recording medium 25 at the time of image playback. The read image data is played back by the image processing part 20, and is displayed on the display part 30 as display means via the display control part 28 so that the image data can be viewed.

The display part 30 comprises a liquid crystal, an organic EL or the like, and also serves as the finder of the camera. The display part 30 displays a monitor image at the time of shooting, and displays a decompressed recorded image at the time of image playback. As mentioned above, the user determines the composition and timing to perform a shooting operation while viewing the image displayed on the display part 30.

To allow an image signal from the image pickup device 17 to be displayed on the display part 30 substantially in real time, image data with the display size limited by the AFE part 18 is processed at a high speed in the image processing part 20, and is then displayed on the display part 30 via the display control part 28. At the time of image playback, compressed data recorded in the recording medium 25 is read by the record/playback control part 24, is played back by the image processing part 20, and is displayed on the display part 30.

The display part 30 can display a so-called slide show of sequentially displaying images with a predetermined transition effect, as well as display a list of a plurality of images captured within a given time, and enlarge and display an image selected from the images. The MPU 11 controls the display control part 28 according to a predetermined program to determine which image is to be played back and which image is given various transition effects. At that time, the record/playback control part 24 adequately reads contents recorded in the recording medium 25 and selects an image to be played back according to the user's operation or a predetermined algorithm.

The display control part 28 is configured to include an enlarging part 28a, an FIFO part (Fade-In Fade-Out) 28b, and a moving part 28c. The enlarging part 28a has a function of gradually enlarging a selected image. The FIFO part 28b has a function of controlling FIFO. The moving part 28c has a function of moving an image within the screen. The display control part 28 can impart the aforementioned effects to the selected image and display the image by activating those functions.

The fill-light emitting part 32 assists exposure. When the subject is relatively or absolutely dark, intense light emitted from the fill-light emitting part 32 is used as fill light. The fill-light emitting part 32 is assumed to be a light source, such as a white LED or xenon (Xe) discharge arc tube, the amount of whose light can be controlled with the amount of current to flow.

Further, a scene determining part 11a and an exposure control part 11b are provided in the MPU 11 as one of the processing functions of the MPU 11. The exposure control part 11b controls the gamma correction function of the ND filter and aperture, the shutter 16, the fill-light emitting part 32 and the image processing part 20 or the optimizing part 20a based on image data from the AFE part 18 to set the exposure of the image to the adequate level.

When displaying a monitor image at the time of shooting, particularly, the exposure control part 11b performs exposure control so that the aspect of the subject on the entire screen can be checked. Specifically, exposure control is executed according to the data reading control for the image pickup device 17.

The scene determining part 11a determines the brightness of the entire screen from the monitor image on the display part 30 to determine whether a current scene is a dark one or a backlight one. The scene determining part 11a also uses a wide range of image data from the image pickup device 17 in making the determination. The scene determining part 11a uses the detection result from the important-portion detecting part 21 in determining a scene. The exposure control part 11b changes the amount of light input to the image pickup device 17 according to the result of the scene determination.

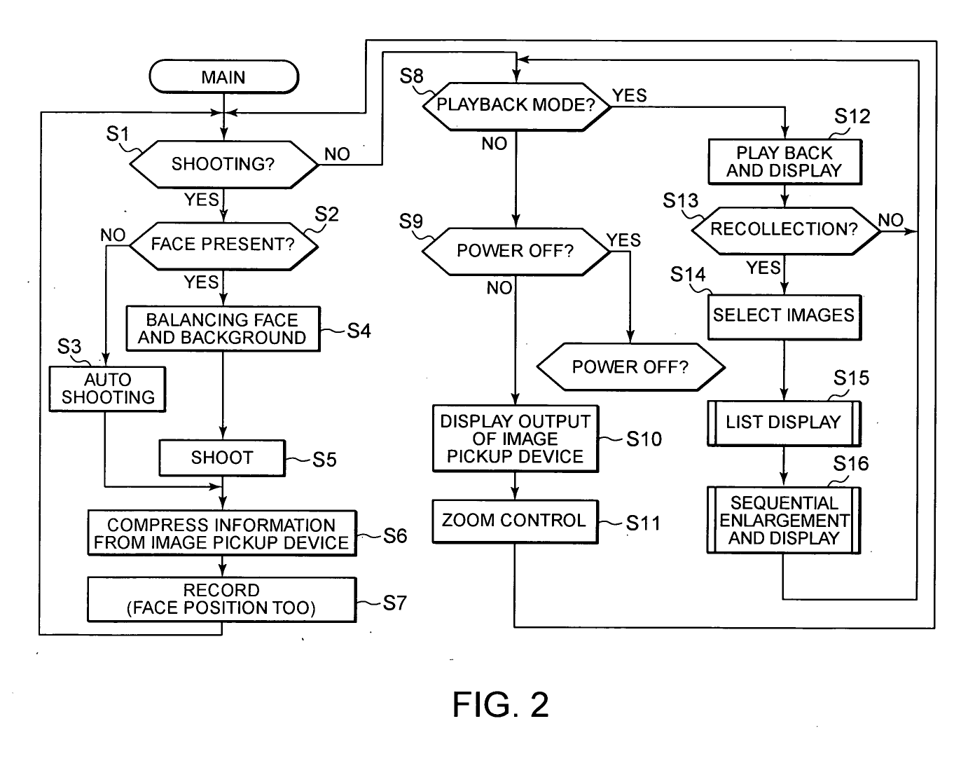

Next, the shooting operation of the thus configured camera will be described referring to a flowchart in FIG. 2. The operation of the camera is executed mainly under the control of the MPU 11 in the camera.

When the power switch (not shown) is set on, this sequence is initiated. First, it is determined in step S1 whether the user has performed an operation for shooting. When the operation of shooting is performed, the sequence goes to step S2. The sequence goes to step S8 otherwise.

In step S2, it is determined if a facial portion is present in an image to be shot. When there is a facial portion, the sequence goes to step S4 where exposure control to balance the appearance of the facial portion and background is executed. The exposure control is executed by a combination of exposure correction, gamma correction, fill-light emission and the like. Those processes are executed by the optimizing part 20a. With such control executed, shooting is carried out in the following step S5. When it is determined in step S2 that there is no face, the sequence goes to step S3 to perform shooting under exposure control with the ordinary average metered light (AUTO shooting).

The image acquired by the image pickup device 17 this way is compressed in step S6, and recorded in step S7. At this time, the result of the facial detection may be recorded together. That is, information on the size and position of the face is recorded along with image data.

When it is not determined in step S1 that the shooting operation is not executed, it is determined whether it is the playback mode. When it is not determined in step S8 that it is the playback mode, the state of the power switch (not shown) is detected in the next step S9. When the power switch is OFF, control is executed to set the power off. Otherwise, the sequence goes to step S10 to display the captured image on the display part 30 in real time. While observing the displayed image, the user has only to determine the timing and composition for shooting and perform the shooting operation. In case the camera is a zoom-function installed model, when the user executes a zoom operation while observing the displayed image in step S10, the camera executes zoom control according to the zoom operation. Thereafter, the sequence goes to step S1.

When the playback mode is set by the user using a mode switch (not shown) in step S8, the sequence goes to step S12 to enter the playback mode to display the shot image. Although the detailed flowchart is not illustrated, the shot image has only to be displayed according to the user's preference, for example by using the function of a thumbnail list display, the enlarged display of an image selected from the list, slide show of sequentially outputting images.

The display method according to the embodiment can allow the user to perform, for example, an operation to effectively recollect memories of an event or a travel from the shot results captured at the time thereof. That is, whether to assist to recollect memories or not is determined in step S13. When the user does not want to recollect memories, the sequence goes to step S8, whereas when the user wants to recollect memories, the sequence goes to step S14.

In step S14, the user selects an event or the like the user wants to see from a calender display or a thumbnail display. The selection result is displayed by sub routines in steps S15 and S16 which will be elaborated later.

In step S15, first, a list of images captured in the event is displayed to visually show how many images have been captured with a collection of the images. In addition, the images on the list are placed evenly on the screen for enjoyment of the overall mood. In the next step S16, an effect is imparted to the images where those images are sequentially enlarged to show the contents in detail to assist the recollection of memories. Then, the sequence goes to step S8.

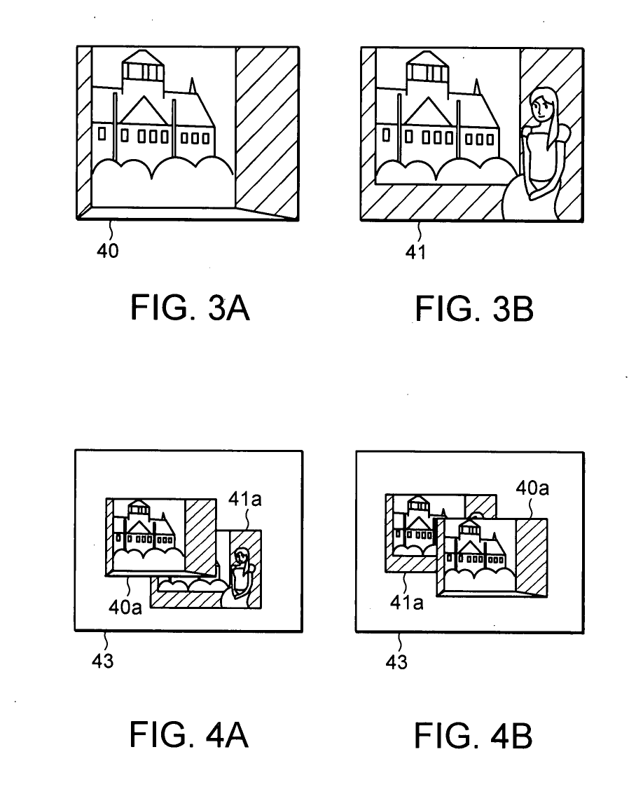

In the list display of the step S15 explained above, it is desirable to make the user understand that scenes taken in an event, for example a scene 40 as shown in FIG. 3A and a scene 41 as shown in FIG. 3B, have been captured at the same event. That is, in a case of list display as shown in FIGS. 4A and 4B, two images 40a and 41a are overlaid one another to indicate that the two images are taken at the same event as shown in FIG. 4A. Further, it is desirable that the facial portion of the subject which is an important portion in the image displayed in FIG. 3B should be made viewable. With the images overlying as shown in FIG. 4B, for example, the face of the subject is not seen and similar pictures are laid out side by side, so that a variety of effects cannot be expected and the two images are difficult to distinguish.

Accordingly, the present invention employs the display method that the important portion (e.g, a face) of each image can be seen.

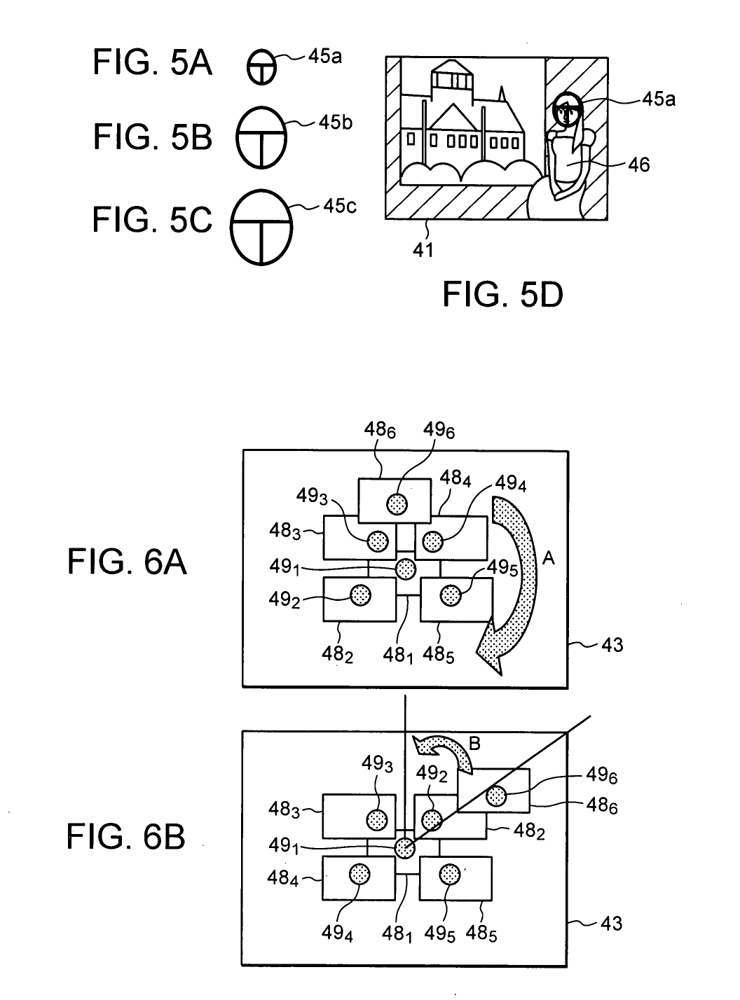

Referring to FIGS. 5A to 5D, a description will be given of an example where it is determined whether a person is present in the screen through facial detection. While there are various portions by which the presence of a person is determined, the description will be given of an example where it is detected if a facial pattern is present in the screen.

FIG. 5A is a diagram showing a reference facial similarity pattern 45a. Likewise, FIGS. 5B and 5C are diagram respectively showing facial similarity patterns 45b and 45c of different facial sizes. Those facial similarity patterns 45b and 45c are stored in the ROM 26. The scene 41 shown in FIG. 5D is the same scene as shown in FIG. 3B.

The important-portion detecting part 21 scans the reference facial similarity pattern 45a in the screen in the scene 41 shown in FIG. 3B. When there is a matched portion, the important-portion detecting part 21 determines that there is a person in the captured image. In the example shown in FIG. 5D, the facial similarity pattern 45a shown in FIG. 5A matches with a person 46.

The above-described method can determine if there is a person in the screen. The method of detecting if there is a person in the screen is not limited to the above-described method.

If such facial detection and analysis of an important portion of each image based on another image analysis can be executed, it is possible to display multiple pieces of image data within a limited range without hiding an important portion of each image as shown in FIGS. 6A and 6B. Viewing such a display, the user can grasp the amount of shots at a glance and can remember the time when multiple images were shot.

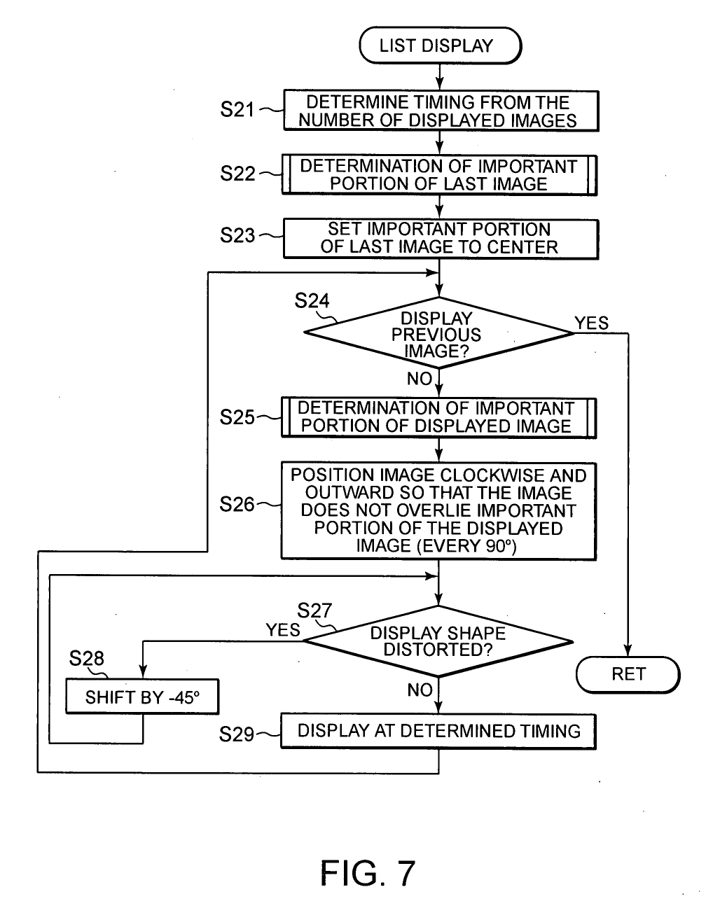

According to the embodiment, as will be explained referring to a flowchart in FIG. 7, control is executed in such a way that an image captured last is displayed in the center and images captured before the image captured last are laid out around the last image clockwise. If images are simply laid out in the same pattern, however, some images may significantly come out of the general arrangement on the screen as shown in FIG. 6B. Therefore, images are displayed closer to the center portion while changing the regularity as indicated by an arrow A in FIG. 6A. That is, in the case of FIG. 6B, an image 486 is arranged at a position indicated by the direction of an arrow B in FIG. 6B. In FIGS. 6A and 6B, “43” represents the screen, “48₁”, “48₂”, . . . , “48₆” represent images, and “49₁”, “49₂”, . . . , “49₆” represent important portions.

The speed of displaying each image in a list of multiple images is set faster when many images are displayed to show excitement at the time of shooting the images.

Referring to the flowchart in FIG. 7, the operation of the sub routine “list display” in step S15 in the flowchart in FIG. 2 will be described.

When the sub routine starts, first, the timing of displaying a next image is determined based on the number of images to be displayed in step S21. This timing can be set to a constant value based on the timer function in the MPU 11 or in the display control part 28, regardless of the number of images. Next, the important portion of the last image in the series of images is determined in step S22. The detailed operation of a sub routine “determination of important portion of last image” in the step S22 will be described later. Then, the last image is displayed in a center portion of the screen in step S23.

In step S24, it is determined whether there is any image captured previously that is to be displayed. When there is no image to be displayed, the sequence leaves this sub routine, and goes to step S16 in the flowchart in FIG. 2. When there is a previous image to be displayed, on the other hand, the sequence goes to step S25 to determine the position of an important portion of the image displayed already. The detailed operation of a sub routine “determination of important portion of displayed image” in the step S25 will be described later.

In the next step S26, each image to be displayed is arranged clockwise in each 90 degrees separation with other one and outwardly so as not to hide an important portion of images already displayed. However, as is displayed in FIG. 6B, an alignment of images largely deviating from circle shape is not preferable. When such an arrangement would takes place, therefore, the display shape is evaluated in step S27. When the display shape is not preferable, the sequence goes to step S28 where the 90-degree shift is changed to a 45-degree shift to display the image. Thereafter, the sequence goes to step S27.

When the display positioned in the step S35 is acceptable, the sequence goes to step S29. In the step S29, images are displayed at the timing determined in the step S21. Thereafter, the sequence goes to step S24.

Although the display position is changed by 90 degrees and 45 degrees, the display position may be changed according to the number of images to be displayed. That is, the greater the number of images is, the smaller the angle becomes to be able to display a greater number of images.

The clockwise image arrangement is not restrictive, and the display positions of images are not limited to those illustrated in FIGS. 6A and 6B.

Such display is effected to show the camera user the mood at the time the series of image were captured.

In the next phase, enlargement-and-display is executed so that each image can be seen in large size and clear appearance (step S16 in the flowchart in FIG. 2). Various enlarging and display method are available for the enlargement-and-display.

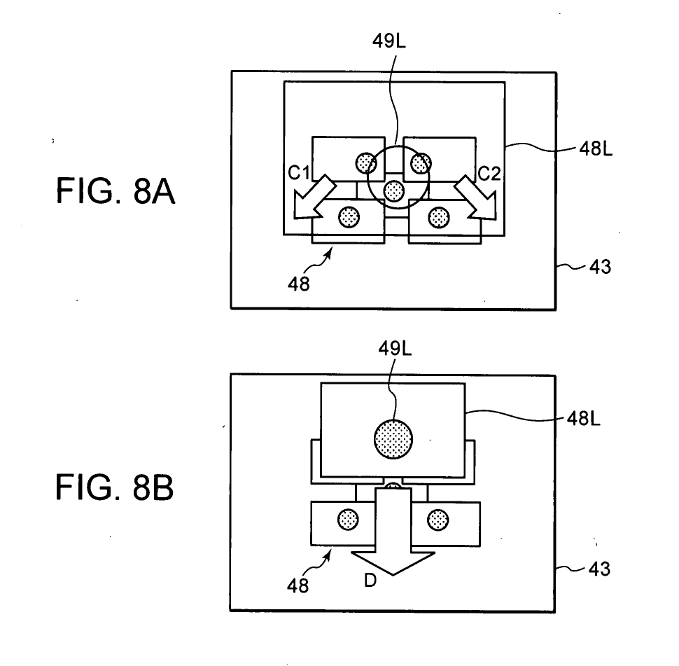

As shown in FIG. 8A, for example, one such method is to gradually expanding an enlarged image 48L with respect to the entire screen as indicated by arrows C1 and C2. At this time, images 48 displayed under the enlarged image 48L are hidden and disappear, so an effect of gradual fading out of the enlarged image 48L is added. In FIGS. 8A and 8B, “49L” denotes an important portion. It is also possible that the enlarged image 48L is not fully zoomed up to the entire screen, and may be stopped its expansion at a certain size and fade out thereafter.

As shown in FIG. 8B, there can be a method of expanding the enlarged image 48L to a predetermined size, then causing the enlarged image 48L to disappear, for example, in the direction of an arrow D. Accordingly, the image 48 displayed under the enlarged image 48L is temporarily hid, but becomes visible after the enlarged image 48L moves out of the screen.

In the embodiment, there are the two methods available to sequentially enlarge individual images without finally hiding a list of images displayed. This image display can bring each scene back into the mind sequentially while the user enjoys the mutual effect of multiple memories.

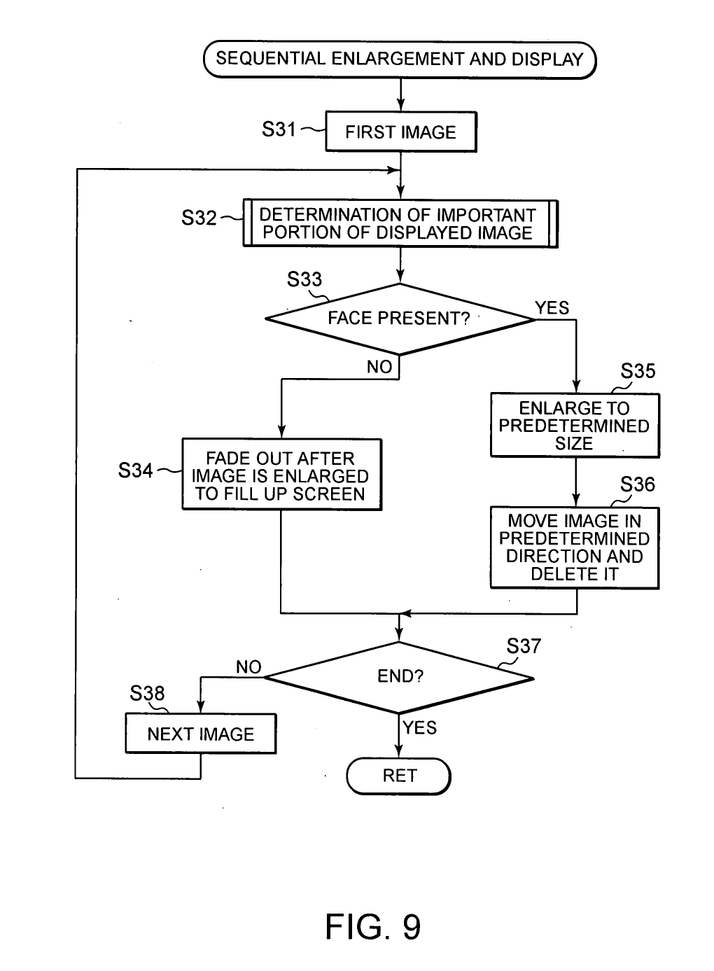

As one way of selecting one method from the two display method, as shown in a flowchart in FIG. 9, the selection can be based on the fact that the present images are portrait or landscape, depending on whether the picture contains a face or not.

Referring to the flowchart in FIG. 9, the operation of the sub routine “sequential enlargement display” in step S16 in the flowchart in FIG. 2 will be described.

When the sub routine starts, first, an image shot first is selected in step S31. Next, a sub routine “determination of important portion of displayed image” is executed in step S32. In step S33, it is determined if the important portion of the image determined in the step S32 is a face.

When the important portion is a face, the sequence goes to step S35 to enlarge the image to a predetermined size. In the next step S36, display is presented in such a way that the image moves across the screen (see FIG. 8B). When an important portion in the image is a face, it is required that the image has an impression as a snap shot that captures just the shot moment from the point of time-scale. In this case, the display of the general unity is important and it is not preferable to effect enlargement beyond what is needed, such as unnatural enlargement of only a portion of the background or a person. Further, it is not preferable that the image overlaps with another image in fade-out process.

On the other hand, a landscape, a small article or the like is often an image spatially cut out from the atmosphere at the shot moment and can often endure the effect of partly enlarging and fading out. When it is determined in the step S33 that the important portion is not a face, therefore, the sequence goes to step S34 to give such an expression as to cause the image to fade out while being enlarged over the entire screen, as shown in FIG. 8A.

In step S37, it is determined if there is no next image and the process can be terminated. The above-described image display method is repeated until there is no more image available. When there is a next image, the image captured next is selected in step S38. Then, the sequence goes to the step S32 where the image is displayed and caused to disappear by a similar enlarging method.

Therefore, it is possible to bring about the effect of displaying images as if memories were remembered and disappeared sequentially. This can provide an image display method which, unlike a simple slide show of sequentially displaying images, stimulates creativity more richly by the mutual effect of the general mood and the moods of the individual images.

While the first image captured is selected in step S31 in the flowchart in FIG. 9, the first image to be selected is not limited to such an image. For example, the last image captured may be selected instead.

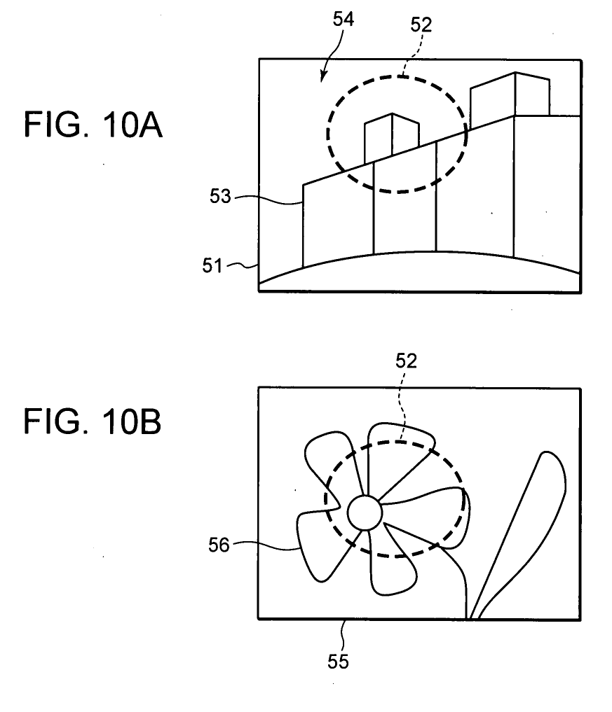

The foregoing description has been given of the example where an important portion of an image is a facial portion included in the image. Even with a landscape picture or a macro picture like a picture of a flower being a target, however, as a portion indicated by a broken line 52 in FIGS. 10A and 10B is taken as an important portion, the mood of the image can be adequately expressed though partially. Even when images are displayed overlying one on another as shown in FIG. 6A, by uncovering the important portion, it is possible to directly express what kind of picture is included.

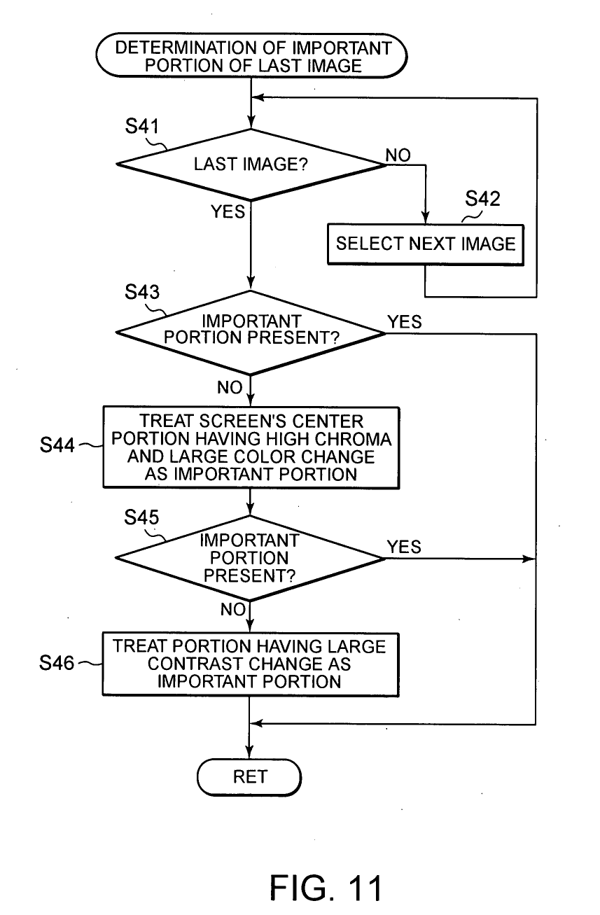

With regard to the selection of an important portion of an image, in a scene 51 as shown in FIG. 10A, for example, setting the boundary between a building 53 and sky 54 as an important portion (representative portion), rather than setting the center portion of the building 53 as an important portion, makes the relationship between the background and the building clearer, thus making it easier to grasp the content of the picture. To determine such a portion, a portion with a large contrast change should be extracted as specified in step S46 in a flowchart in FIG. 11 to be described later. Note that the sky 54 has a low contrast whereas the building 53 has a high contrast.

In a scene 55 as shown in FIG. 10B, the center portion of a flower 56 and an area including petals should be set as an important portion 52. This portion can be selected by choosing a portion which shows a clear difference in wavelength distribution and has a high chroma and a large color change from the image. For example, determination should be made as specified in step S44 in the flowchart in FIG. 11. It is already explained that in case of displaying images, the important portion of each image should be considered. In this case, an important portion of each image is determined referring to the flowchart as shown in FIG. 11.

Referring to the flowchart in FIG. 11, the operation of the sub routine “determination of important portion of last image” in the step S22 in the flowchart in FIG. 7 will be described below. When the sub routine starts, first, it is determined whether the image is a last one in step S41. If the image is not the last one, the sequence goes to step S42 to select a next image. Then, the sequence returns to the step S41 and the loop is repeated until the last image is detected.

If it is determined in the step S41 that the image is the last one, the sequence goes to step S43 to detect if there is a face or another important portion. The detection can be done at the time of shooting if such is a case, or can be done at the time of image display. When there is an important portion in step S43, the sequence leaves the sub routine and goes to step S23 in the flowchart in FIG. 7. When there is no important portion in step S43, on the other hand, the sequence goes to step S44 to set a center portion of the image if it has a high chroma and a large color change as an important portion.

The determination of an area which has a high chroma and a large color change will be explained below.

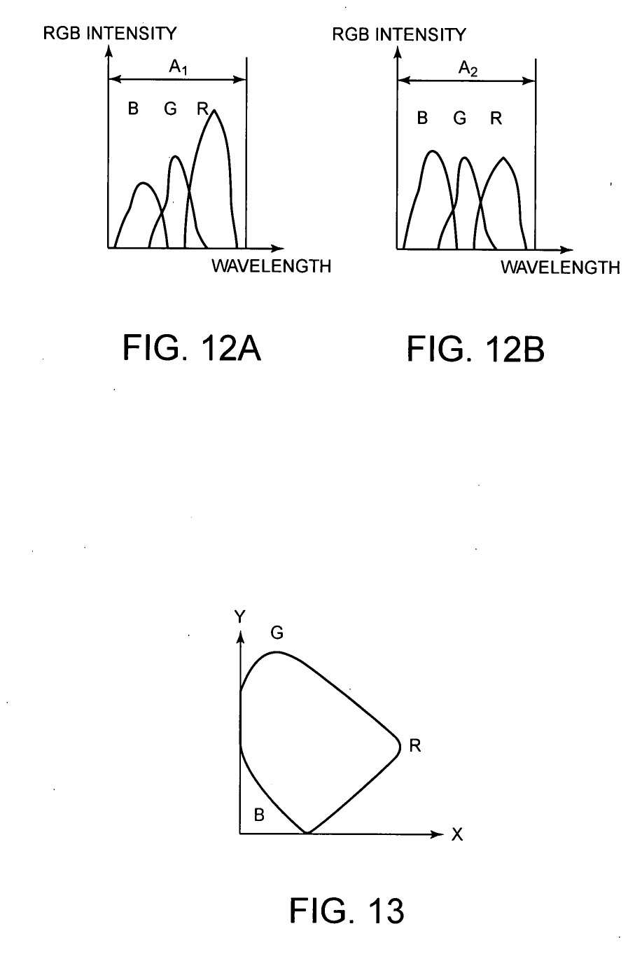

The determination of an area which has a high chroma and a large color change can be made by, for example, checking the levels of RGB signals which has passed through color filters (not shown) of the image pickup device 17 for each area (A1, A2, . . .) in the screen as shown in FIGS. 12A and 12B, and selecting an area which has a large level difference, or selecting an area which has a distinctive distribution (a portion having a pattern different from that of the periphery taken as the background) as a candidate area.

Alternatively, the RGB signals are converted by predetermined coordinate conversion to be expressed by the XYZ coordinates of the CIE display color system or the like as color space, with the luminance taken on the Y axis. The result is a chromaticity diagram shown in FIG. 13.

For example, an area on the image pickup device 17 which has coordinates distant from the center portion on the chromaticity diagram can be determined as a location where a subject with clear colors (high chroma) is present. Of course, with regard to a white flower or the like on a red carpet, it is desirable to make the flower stand out, so that when the periphery has a high chroma and the center portion has a low chroma, a portion showing a change in chroma may be displayed by priority.

In step S45, the presence/absence of an important portion is detected again. When an important portion is detected, the sequence leaves the sub routine and goes to step S23 in the flowchart in FIG. 7. When there is no important portion in step S45, on the other hand, the sequence goes to step S46 to set a portion with a large contrast change as the important portion.

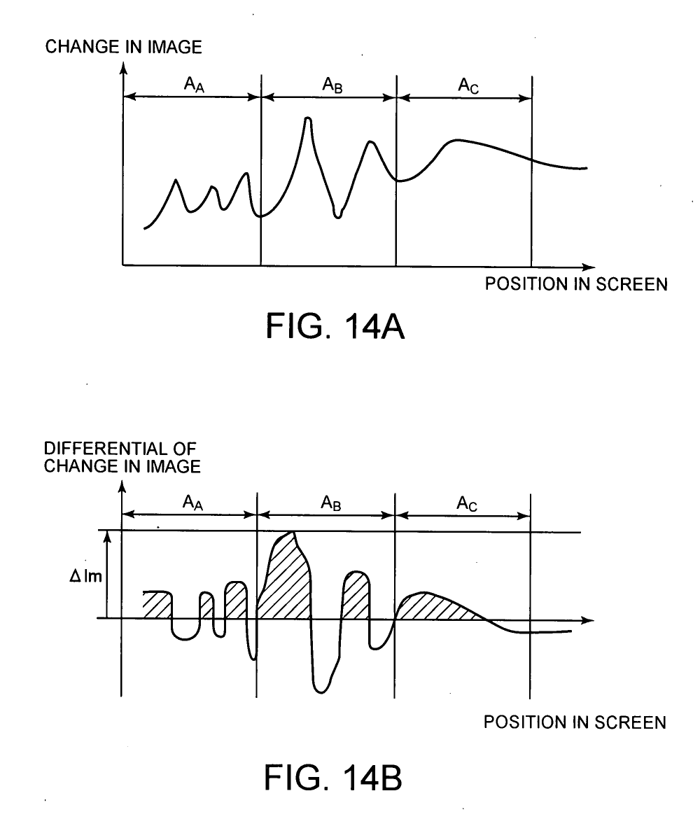

A change in contrast will be described next. The determination of an area with a large contrast change may be made by selecting an area which provides the peak ΔIm of a differential signal, as shown in FIG. 14B (area AB portion). The differential signal, for example, can be obtained by differencing changes in an image obtained in the horizontal direction at a predetermined vertical position of the image pickup device 17 as shown in FIG. 14A. An area in which a portion of the differential signal which has a large area of a positive value (integral value) is located (area AB portion) can be selected as indicated by hatches in FIG. 14B. Further, a portion having a very high contrast may be neglected or a color change may be added thereto.

This determination method can make it possible to determine, by priority, a portion which easy to show a change in image or a portion having a high contrast.

Thereafter, the sequence leaves the sub routine and goes to step S23 in the flowchart in FIG. 7.

In the steps S44 and S46 described above, an important portion is determined from the color and contrast. The reason why color is taken into consideration largely in the embodiment is that at the display of images, even a small image can appeal to the sensation of the viewer if it has vivid colors.

When the displayed images are consisted of similar pictures, however, these similar images are arranged sequentially and which is not fun at all. In a situation where same determination will always be made, therefore, the scheme of determining an important portion can be changed at random.

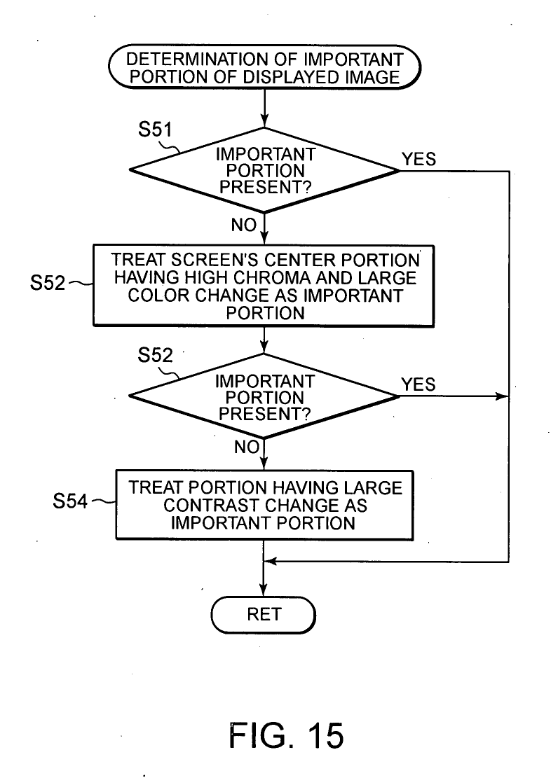

FIG. 15 is a flowchart for explaining the operation of a sub routine “determination of important portion of displayed image” in step S25 in the flowchart in FIG. 7 and in step S32 in the flowchart in FIG. 9.

Because the operations of steps S51 to S54 in the sub routine are same as the operations of steps S43 to S46 in the flowchart in FIG. 11, their descriptions should be referred to the corresponding descriptions given above and will be omitted.

As apparent from the above, the embodiment displays a list of a plurality of images arranged on the display part in such a way that individual images at least partially overlie one another, so that a plurality of images can be displayed on the screen efficiently.

As images are arranged in the list display in such a way that an important portion of each image is not hid by another image, it is easier for a user to understand the feature of each image in the list.

The embodiment employs a display mode in which images are sequentially enlarged and disappear from the screen. This display mode is therefore effective when the user recollects individual scenes. In this case, the display mode is provided with a first enlarge and display mode in which individual images are sequentially enlarged to the full screen size or a predetermined size and then the enlarged and displayed images are caused to fade out of the screen of the display part, and a second enlarge and display mode in which individual images are sequentially enlarged to a predetermined size and then the enlarged and displayed images are moved out of the screen. This can allow the user to select the proper display effect according to the feature of an image.

After a list of a plurality of images is displayed, each image is enlarged and displayed for emphasizing. This makes it easier for the user to remember the memories of an event or the like as a whole, and then remember each scene of an individual image, and is therefore suitable for memory recollection.

As apparent from the above, the embodiment is suitable for effectively presenting a user with a plurality of images to help the user recollect memories.

While there has been shown and described what are considered to be preferred embodiments of the invention, it will, of course, be understood that various modifications and changes in form or detail could readily be made without departing from the spirit of the invention. It is therefore intended that the invention not be limited to the exact forms described and illustrated, but constructed to cover all modifications that may fall within the scope of the appended claims.

What is claimed is:

1. An image display method for displaying a plurality of input images on a display part, comprising:
selecting and sequentially inputting a plurality of images to be displayed;
displaying a list of the sequentially input plurality of images on the display part in such a way that the displayed images at least partially overlap one another; and
sequentially enlarging and displaying individual images in the displayed list, and then causing the enlarged and displayed images to disappear from a screen of the display part.

2. The image display method according to claim 1, wherein at sequentially enlarging and displaying the individual images in the displayed list, the individual images are sequentially enlarged to a screen-full size and are displayed, then at disappearing of the individual images, the enlarged and displayed individual images are caused to fade out.

3. The image display method according to claim 1, wherein at sequentially enlarging and displaying the individual images in the displayed list, the individual images are enlarged to a predetermined size, and are displayed, then at disappearing of the individual images, the enlarged and displayed individual images are caused to move out of the screen.

4. The image display method according to claim 1, further comprising detecting an important portion in each image based on at least one of contrast of each image, chroma thereof, and presence or absence of a face therein.

5. The image display method according to claim 1, wherein there are two ways of sequentially enlarging, displaying and causing to disappear the individual images in the displayed list, and the method further includes selecting a way from the two ways,
in one way, the individual images are sequentially enlarged to a screen-full size, are displayed, and are caused to fade out,
in the other way, the individual images are enlarged to a predetermined size, are displayed, and are caused to move out of the screen.

6. The image display method according to claim 5, further comprising detecting an important portion in each image based on at least one of contrast of each image, chroma thereof, and presence or absence of a face therein.

7. The image display method according to claim 6, wherein the selecting a way is executed based on the detected important portion.

8. The image display method according to claim 4, wherein at a time of displaying the list of images, sequentially overlaying the images one on another, the images are arranged in such a way that the important portion of each of the images is not hid by another image.

9. The image display method according to claim 1, wherein a time needed for displaying the list of images is constant regardless of a quantity of the images input.

10. An image display apparatus comprising:
a display part that displays a group of images comprised of a plurality of captured images; and
a display control part that performs enlargement and display of selecting and sequentially inputting the images to be displayed, arranging the plurality of images sequentially input on the display part in such a way that displayed images at least partially overlie one another, sequentially enlarging and displaying individual images in the displayed list, and then causing the enlarged and displayed images to disappear from a screen of the display part.

11. The image display apparatus according to claim 10, wherein the enlargement and display is of sequentially enlarging individual images in the displayed list to a screen-full size, and displaying the images, then causing the enlarged and displayed images to fade out.

12. The image display apparatus according to claim 10, wherein the enlargement and display is of enlarging each image in the displayed list to a predetermined size, and displaying that image, then moving the enlarged and displayed image out of the screen.

13. The image display apparatus according to claim 10, further comprising an important-portion detecting part that detects an important portion in each image based on at least one of contrast of each image, chroma thereof, and presence or absence of a face therein.

14. The image display apparatus according to claim 10, wherein the display control part at least has a first enlarge and display mode in which a list of a plurality of images sequentially input is displayed on the display part in such a way that the images at least partially overlie one another, individual images are sequentially enlarged and then the enlarged and displayed images are caused to fade out of the screen of the display part, and a second enlarge and display mode in which individual images in the displayed list are sequentially enlarged to a predetermined size and then the enlarged and displayed images are moved out of the screen, and
the display control part selects either the first enlarge and display mode or the second enlarge and display mode, and enlarges and displays each image according to the selected enlarge and display mode.

15. The image display apparatus according to claim 14, further comprising an important-portion detecting part that detects an important portion in each image based on at least one of contrast of each image, chroma thereof, and presence or absence of a face therein.

16. The image display apparatus according to claim 15, wherein the display control part selects the enlarged display mode based on the detected important portion.

17. The image display apparatus according to claim 13, wherein at a time of displaying the list of images, sequentially overlaying the images one on another, the images are arranged in such a way that the important portion of each of the images is not hid by another image.

18. The image display apparatus according to claim 10, wherein a time needed for displaying the list of images is constant regardless of a quantity of the images input.

19. A camera comprising:
an imaging part that images a subject to acquire an imaging signal;
a recording part that can record a plurality of captured images of the subject based on the imaging signals acquired by the imaging part;
a display part that displays a group of images comprised of a plurality of captured images recorded in the recording part; and
a display control part that performs display control of selecting and sequentially inputting the images to be displayed, arranging a plurality of images sequentially input on the display part in such a way that displayed images at least partially overlie one another, sequentially enlarging and displaying individual images in the displayed list, and then causing the enlarged and displayed images to disappear from a screen of the display part.

20. The camera according to claim 19, wherein the display control part performs display control in such a way as to sequentially enlarge individual images in the displayed list to a screen-full size, and display the images on the display part, then cause the enlarged and displayed images to fade out.

21. The camera according to claim 19, wherein the display control part enlarges each image in the list displayed on the display part to a predetermined size, and displays that image, then moves the enlarged and displayed image out of the screen.

22. The camera according to claim 19, further comprising an important-portion detecting part that detects an important portion in each image based on at least one of contrast of each image, chroma thereof, and presence or absence of a face therein.

23. The camera according to claim 22, further comprising a storage part that stores facial similarity patterns of different sizes for detecting the presence or absence of a face, and
wherein in detecting an important portion in each image based on at least the presence or absence of a face, the important-portion detecting part detects the important portion based on the facial similarity patterns of different sizes stored in the storage part.

24. The camera according to claim 19, wherein a time needed for displaying the list of images is constant regardless of a quantity of the images input.

25. The camera according to claim 19, wherein the display control part at least has a first enlarge and display mode in which individual images are sequentially enlarged and then the enlarged and displayed images are caused to fade out of the screen of the display part, and a second enlarge and display mode in which individual images in the displayed list are sequentially enlarged to a predetermined size and then the enlarged and displayed images are moved out of the screen, and
the display control part selects either the first enlarge and display mode or the second enlarge and display mode, and enlarges and displays each image according to the selected enlarge and display mode.

26. The camera according to claim 25, further comprising an important-portion detecting part that detects an important portion in each image based on at least one of contrast of each image, chroma thereof, and presence or absence of a face therein.

27. The camera according to claim 26, further comprising a storage part that stores facial similarity patterns of different sizes for detecting the presence or absence of a face, and
wherein in detecting an important portion in each image based on at least the presence or absence of a face, the important-portion detecting part detects the important portion based on the facial similarity patterns of different sizes stored in the storage part.

28. The camera according to claim 26, wherein the display control part selects the enlarged display mode based on the detected important portion.

29. The camera according to claim 22, wherein at a time of displaying the list of images on the display part, sequentially overlaying the images one on another, the display control part arranges the images in such a way that the important portion of each of the images is not hid by another image.
